(19) United States
(12) Patent Application Publication
(10) Pub. No.: US 2014/0376076 A1
(43) Pub. Date: Dec. 25, 2014

(54) VEHICLE LAMP WITH ELECTROCHROMIC ELEMENT

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 13/972,879

(22) Filed: Aug. 21, 2013

(30) Foreign Application Priority Data
Jun. 19, 2013 (TW) 102121664

(51) Int. Cl. F21S 8/10

(52) U.S. Cl. CPC F21S 48/1731
USPC 359/275

(57) ABSTRACT

A vehicle lamp includes a reflector, a light source mounted in the reflector, a cover fixed to the reflector and an electrochromic element embedded into the cover. The light source emits light towards the reflector. The electrochromic element is located at a lower portion of the cover. The electrochromic element turns black when receiving an electricity, and turns transparent when receiving no electricity.

### BACKGROUND

1. Technical Field

The disclosure generally relates to vehicle lamps, and more particularly, to a vehicle lamp with an electrochromic element.

2. Description of Related Art

A vehicle headlamp is generally required to be switchable between a low beam and a high beam. Thus, a movable mechanism may be incorporated to the headlamp for modulating light emitted from the light source. When the movable mechanism moves to a first location, part of the light emitted from the light source will be blocked by the movable mechanism to obtain the low beam. When the movable mechanism moves to a second location, all of the light emitted from the light source can radiate out of the headlamp to obtain the high beam.

However, the movable mechanism is complicated and occupies a large space, thereby resulting in a high cost and a large volume of the headlamp.

What is needed, therefore, is a vehicle lamp with an electrochromic element which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a vehicle lamp in accordance with an embodiment of the present disclosure, wherein an electrochromic element of the vehicle lamp is transparent.

FIG. 2 is similar to FIG. 1, but showing the electrochromic element being opaque.

FIG. 3 is an enlarged view of the electrochromic element of FIG. 1.

### DETAILED DESCRIPTION

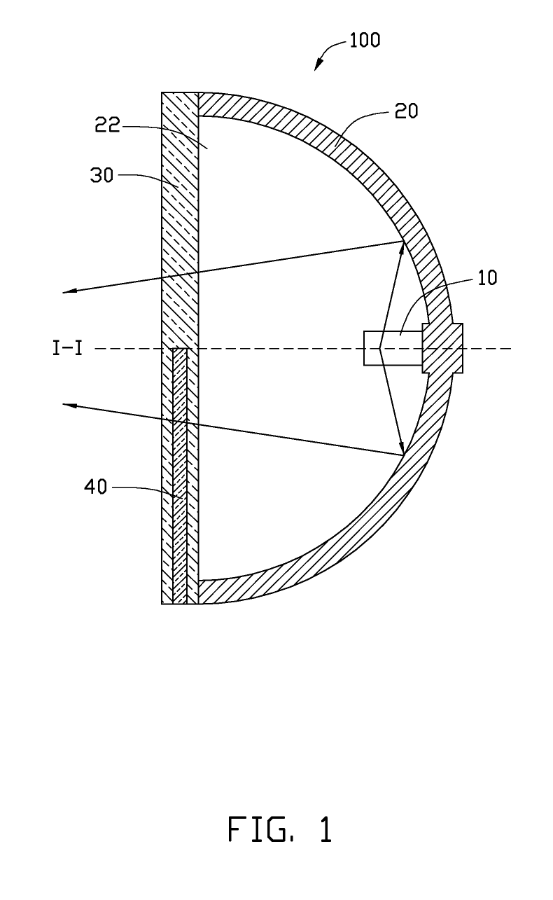

Referring to FIG. 1, a vehicle lamp 100 in accordance with an embodiment of the present disclosure is shown. The vehicle lamp 100 includes a reflector 20, a light source 10 received in the reflector 20, a cover 30 connected to the reflector 20 and an electrochromic element 40 embedded into the cover 30.

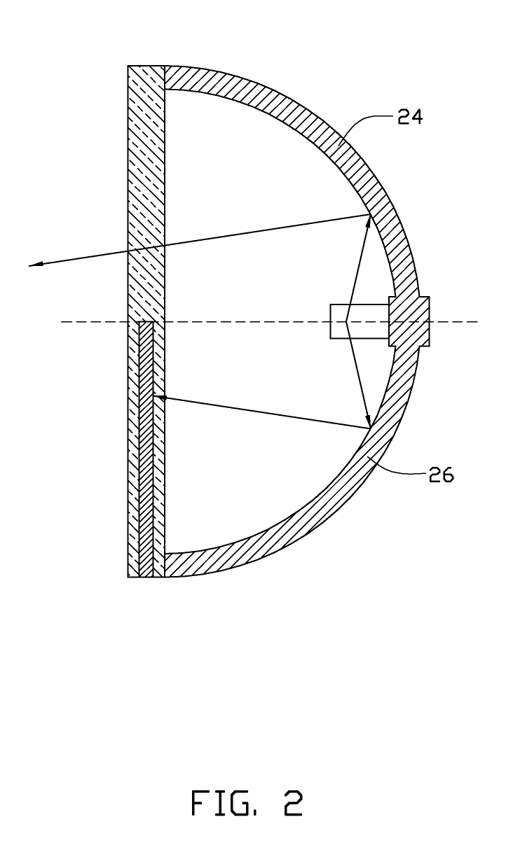

Also referring to FIG. 2, the reflector 20 has a bowl shape. The reflector 20 defines a window 22 in an end thereof. The reflector 20 includes an upper part 24 and a lower part 26 symmetrical with the upper part 24 along a central axis I-I of the reflector 20. The reflector 20 may be made of metal or other suitable reflective materials.

The light source 10 is fixed on an inner face of the reflector 20. The light source 10 may be a light emitting diode, a fluorescent tube, a halogen lamp or other suitable light sources. A light emitting face of the light source 10 faces the inner face of the reflector 20 so that light emitted from the light source 10 all radiates towards the inner face of the reflector 10. In other words, no light directly emitted from the light source 10 radiates towards the cover 30. A part of the light radiating upwardly strikes the upper part 24 of the reflector 20, and is then reflected by the upper part 24 of the reflector 20 to transmit downwardly towards the window 22. Another part of the light radiating downwardly strikes the lower part 26 of the reflector 20, and is then reflected by the lower part 26 of the reflector 20 to transmit upwardly towards the window 22.

The cover 30 is connected to the end of the reflector 20 to cover the window 22. The cover 30 is spaced from the light source 10. The central axis I-I of the reflector 20 extends through a center of the cover 30. The cover 30 may be made of transparent material such as glass, epoxy, silicone or the like. The upwardly transmitting light and the downwardly transmitting light can pass through the cover 30 to illuminate an outside environment.

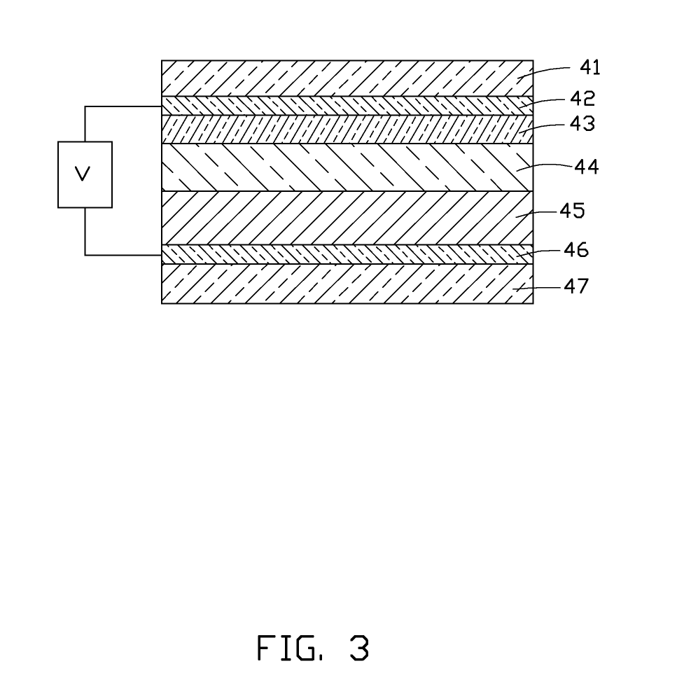

Also referring to FIG. 3, the electrochromic element 40 has an area less than that of the cover 30. The electrochromic element 40 has a thickness less than that of the cover 30. The electrochromic element 40 is parallel to the cover 30 and perpendicular to the central axis I-I of the reflector 20. The electhromic element 40 is located below the central axis I-I of the reflector 20. The electronic element 40 includes a first substrate 41, a first transparent conductive layer 42, an ion storage layer 43, an electrolyte layer 44, an electrochromic layer 45, a second transparent conductive layer 46 and a second substrate 47. The first substrate 41 and the second substrate 47 may be made of transparent material such as glass, epoxy, silicone or the like. The first transparent conductive layer 42 and the second transparent conductive layer 46 may be made of ITO (indium tin oxide). The first transparent conductive layer 42 and the second transparent conductive layer 46 are used to conduct electricity from a power source to the ion storage layer 43, the electrolyte layer 44 and the electrochromic layer 45. The electrochromic layer 45 may be made of WO₃, MoO₃, IrOₓ, polyaniline, viologen, Prussian blue, NiO or other suitable materials. When no electricity is applied, the electrochromic layer 45 remains transparent or translucent so that the light can pass through the electrochromic element 45. When the electricity is applied, the electrochromic layer 45 turns opaque so that the light is blocked by the electrochromic element 45. The ion storage layer 43 is used to store ion when the electrochromic layer 45 is electrified, thereby maintaining balance of electric charge within the electrochromic element 40. The electrolyte layer 44 may be made of pota iumperchlorate, sodium perchlorate or other suitable electrically conductive material.

When the vehicle lamp 100 is required to switch to a high beam, no electricity is applied to the electrochromic element 40. Thus, the upwardly transmitting light and the downwardly transmitting light reflected by the reflector 20 can all pass through the cover 30, thereby cooperatively forming the high beam. When the vehicle lamp 100 is required to switch to a low beam, the electricity is applied to the electrochromic element 40. Thus, the upwardly transmitting light reflected by the lower part 26 of the reflector 20 is blocked by the electrochromic element 40, and thus fails to pass through the cover 30 to the outside environment. Only the downwardly transmitting light reflected by the upper part 24 of the reflector 20 can pass through the cover 30 to the outside environment, thereby forming the low beam alone. The electrochromic element 40 has a low cost, whereby the whole cost of the vehicle lamp 100 is reduced accordingly. Furthermore, the electrochromic element 40 also has a small size, whereby a volume of the vehicle lamp 100 can be controlled small enough.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A vehicle lamp comprising:
a reflector;
a light source emitting light towards the reflector;
a cover mounted to the reflector; and
an electrochromic element switchable between a light transmittable state and an opaque state;
wherein a first part of the light emitted from the light source is reflected by the reflector towards the cover, and a second part of the light emitted from the light source is reflected by the reflector towards the electrochromic element;
wherein when the electrochromic element is switched to the light transmittable state, the first part of the light passes through the cover and the second part of the light passes through the electrochromic element, cooperatively forming a high beam; and
wherein when the electrochromic element is switched to the opaque state, the second part of the light is blocked by the electrochromic element, and the first part of the light passes through the cover to form a low beam.

2. The vehicle lamp of claim 1, wherein the light source is directly connected to the reflector.

3. The vehicle lamp of claim 1, wherein the light source emits no light towards the cover directly.

4. The vehicle lamp of claim 1, wherein the light source comprises a light emitting diode.

5. The vehicle lamp of claim 1, wherein the light source is spaced from the cover.

6. The vehicle lamp of claim 1, wherein the reflector defines a window in an end thereof, the cover being directed connected to the reflector and covering the window.

7. The vehicle lamp of claim 1, wherein the cover has a thickness larger than a thickness of the electrochromic element.

8. The vehicle lamp of claim 1, wherein the electrochromic element is totally incorporated within the cover.

9. The vehicle lamp of claim 1, wherein the electrochromic element has an area less than an area of the cover.

10. The vehicle lamp of claim 1, wherein the electrochromic element is parallel to the cover.

11. The vehicle lamp of claim 1, wherein the reflector has a central axis extending through the cover, the electrochromic element being located beneath the central axis.

12. The vehicle lamp of claim 1, wherein the electrochromic element turns black when receiving an electricity, and turns transparent when receiving no electricity.

13. The vehicle lamp of claim 1, wherein the electrochromic element comprises an ion storage layer, an electrochromic layer, and an electrolyte layer sandwiched between the ion storage layer and the electrochromic layer.

14. The vehicle lamp of claim 13, wherein the electrochromic element comprises a first transparent conductive layer and a second transparent conductive layer, the ion storage layer, the electrochromic layer and the electrolyte layer being sandwiched between the first transparent conductive layer and the second transparent conductive layer.

15. The vehicle lamp of claim 14, wherein the electrochromic element comprises a first substrate and a second substrate, the first transparent conductive layer, the ion storage layer, the electrochromic layer, the electrolyte layer and the second transparent conductive layer being sandwiched between the first substrate and the second substrate.

16. The vehicle lamp of claim 15, wherein the first substrate and the second substrate are made of the same transparent material as the cover.

17. The vehicle lamp of claim 1, wherein the electrochromic element is made of WO₃ or MoO₃.

18. The vehicle lamp of claim 1, wherein the vehicle lamp is a headlamp.
